(19) United States
(12) Patent Application Publication
(10) Pub. No.: US 2010/0329218 A1
(43) Pub. Date: Dec. 30, 2010

(54) WIRELESS COMMUNICATION TERMINAL DEVICE AND COMMUNICATION SYSTEM CATCHING CONTROL METHOD

(75) Inventor: Hideyuki Hoshino, Yokohama-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/667,020

(22) PCT Filed: Jun. 30, 2008
(86) PCT No.: PCT/JP2008/061818

§ 371 Date: Mar. 5, 2010

(30) Foreign Application Priority Data
Jun. 28, 2007 (JP) 2007-171284

(51) Int. Cl. H04B 7/216; H04B 7/00

(52) U.S. Cl. 370/335; 455/525

(57) ABSTRACT

It is an object to provide a wireless communication terminal apparatus and a communication system acquisition control method that efficiently carry out the reselection among a plurality of communication systems to reduce electric power consumption and that can prevent a acquisition failure of an incoming call as much as possible. A control unit (18) includes a first reselection timer (long period timer (201)) that starts up reselection processing to shift from a registration state in a low priority communication system to a registration state in a high priority communication system and a second reselection timer that is shorter in period than that of the first reselection timer. When communication is carried out at in a registration state in a low priority communication system, the control unit registers base station information to use at a memory unit (17) and judges whether or not the base station information of a base station is registered at the memory unit (17) when in registration after the communication is finished. The control unit carries out the reselection processing by using the long period timer (201) in the case where the information is registered at the memory unit (17), or otherwise, the control unit carries out the reselection processing by using the short period timer (202).

### TECHNICAL FIELD

The present invention relates to a wireless communication terminal apparatus able to adapt a plurality of communication systems synchronized temporally each other, and a communication system acquisition control method of the same.

### BACKGROUND ART

In a mobile terminal apparatus connecting with a network through a base station, in order to maintain the communication quality, it has been required to always select the best base station.

For this reason, in order to acquire a neighbor cell at a high speed, for example, a technique of receiving neighbor base station information from a base station in a cell currently standing by at and changing the standby (registration) cell, in the CDMA (Code Division Multiple Access) 2000 1x system, is known (see, for example, Patent Document 1 and Patent Document 2).

Patent Document 1: Japanese Patent Publication (A) No. 2005-260425

Patent Document 2: Japanese Patent Publication (A) No. 2005-260427

### DISCLOSURE OF THE INVENTION

### Problem To Be Solved By the Invention

The above Patent Documents 1 and 2 disclose only the change of base stations in a single communication system in a 2000 1x communication system and EVDO (Evolution Data Only) communication system, and do not disclose details of a mobile terminal apparatus adapted to a plurality of communication systems.

From the above viewpoint, there is desired to provide a wireless communication terminal apparatus suppressing power consumption and able to avoid failure of receipt of an incoming call as much as possible even when able to use a plurality of communication systems, and a communication system acquisition control method of the same.

### Means For Solving the Problem

A wireless communication terminal apparatus able to adapt a plurality of communication systems synchronized temporally each other, the wireless communication terminal apparatus comprising: a communication part communicating with base stations by selectively acquiring any one of the plurality of the communication systems; a memory part storing a plurality of sets of base station information; and a control part capable of executing reselection processing that executes acquisition processing when the communication part is registrated at a low priority first communication system, for shifting the communication part to registrate at a high priority second communication system, wherein, when communication starts in a state of registration at the low priority first communication system, the control part registers the base station information of the base station used for the communication in the memory part, when the communication ends and the operation shifts to idle, the control part judges if the base station information of a registrated base station is contained in the base station information stored in the memory part, the control part sets a first reselection timer when it is judged that the base station information of the registrated base station is contained, the control part sets a second reselection timer shorter in period than the first reselection timer when it is judged that the base station information of the registrated base station is not contained, and the control part executes the reselection processing when either the set timer of the first reselection timer or second reselection timer reaches the end of its count.

Further, the wireless communication terminal apparatus of the present invention may be configured so that the base station information stored in the memory part are linked with counters, and when the first reselection timer reaches the end of its count, the control part makes the counters other than that for the base station used for communication immediately before setting the first reselection timer among the counters of the base station information stored in the memory part approach a predetermined value by a constant quantity, and the control part deletes the base station information linked with a counter reaching the predetermined number from the memory part when any counter reaches the predetermined number.

Further, the wireless communication terminal apparatus of the present invention may be configured so that when performing the reselection processing and failing in the acquisition processing of the high priority second communication system, the control part resets a count value corresponding to the base station information of the base station registrated at immediately before.

Further, the wireless communication terminal apparatus of the present invention may be configured so that the control part performs the reselection processing and deletes the base station information of the base station idled at immediately before from the memory part when able to idle at the second communication system with a high priority.

Further, the wireless communication terminal apparatus of the present invention may be configured so that the control part deletes all of the base station information of the memory part when a registrated time at the high priority second communication system continues for a predetermined time or longer.

Further, the wireless communication terminal apparatus of the present invention may be configured so that when a registrated time at the high priority second communication system is within a predetermined time, the control part makes the counter for each of the base station information of the memory part approach the predetermined value by the amount of value corresponding to the registrated time.

Further, a wireless communication terminal apparatus of the present invention is a wireless communication terminal apparatus able to adapt a plurality of communication systems synchronized temporally each other, the wireless communication terminal apparatus comprising: a reselection means for executing acquisition processing when the terminal apparatus is registrated at a low priority first communication system, for shifting the registrated communication system to a high priority second communication system; a timer means for activating the reselection means; a storing means for storing a plurality of base station information; a registering means for registering the base station information used in the storing means when the communication is carried out in a state of registration at a communication system with a low priority; and a judging means for judging if the base station information of the registrated base station is contained in the base station information stored by the storing means when ending the communication and shifting to registration, wherein the timer means includes a long period timer and a short period timer, the terminal apparatus performs control a next execution of the reselection means by using the short period timer when the judging means judges that the base station information of the registrated base station is not contained in the base station information, and the terminal apparatus performs control a next execution of the reselection means by using the long period timer when judging that the base station information of the registrated base station is contained.

Further, in the wireless communication terminal apparatus of the present invention, each of the plurality of communication systems is a communication system to which a different band class in the CDMA2000_{—}1x scheme is assigned.

Further, in the wireless communication terminal apparatus of the present invention, the low priority first communication system is a communication system to which a band class 3 is assigned, and the high priority second communication system is a communication system to which a band class 0 is assigned.

Further, in the wireless communication terminal apparatus of the present invention, the high priority second communication system is a communication system which becomes able to be used newer than the low priority first communication system.

Further, a communication system acquisition control method in a wireless communication terminal apparatus of the present invention is a communication system acquisition control method in a wireless communication terminal apparatus able to adapt a plurality of communication systems synchronized temporally each other and having a communication part communicating with base stations by selectively acquiring any one of the plurality of communication systems, including: a registration step of registrating base station information of a base station to be used for communication when communication starts in a state of registration at a low priority first communication system; a judgment step of judging if the base station information of a registrated base station is contained in the base station information registered in the registration step when shifting to registration after the communication ends; a setting step of setting a first reselection timer when it is judged in the judgment step that the base station information of the registrated base station is contained and setting a second reselection timer shorter in period than the reselection timer when it is judged that the base station information of the registrated base station is not contained, and a reselection step of executing reselection processing for acquisition processing when the terminal apparatus is registrated at the low priority first communication system, for shifting the registration of the terminal apparatus to a higher priority second communication system with than the low priority first communication system when either a set timer of the first reselection timer or second reselection timer reaches the end of its count.

### Effects of the Invention

According to the wireless communication terminal apparatus of the present invention and the communication system acquisition control method of the same, even when made able to use a plurality of communication systems, a power consumption is suppressed and missed incoming calls can be avoided as much as possible.

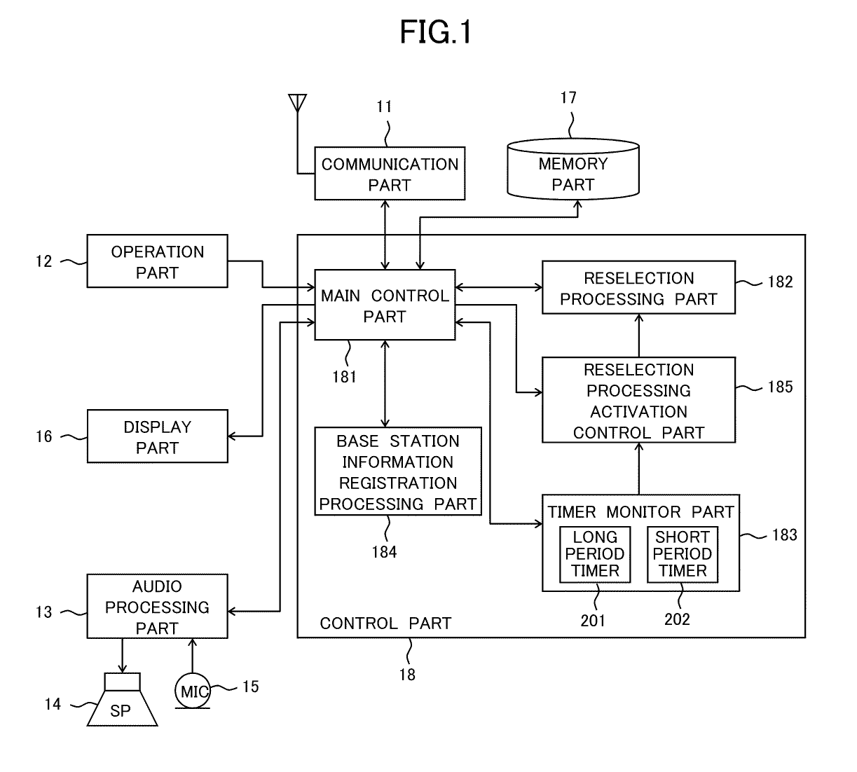

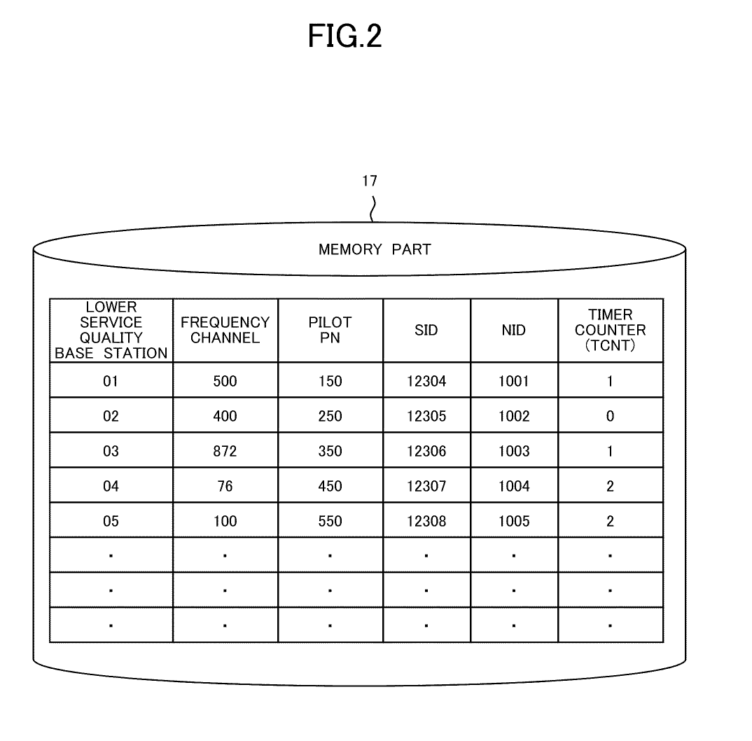

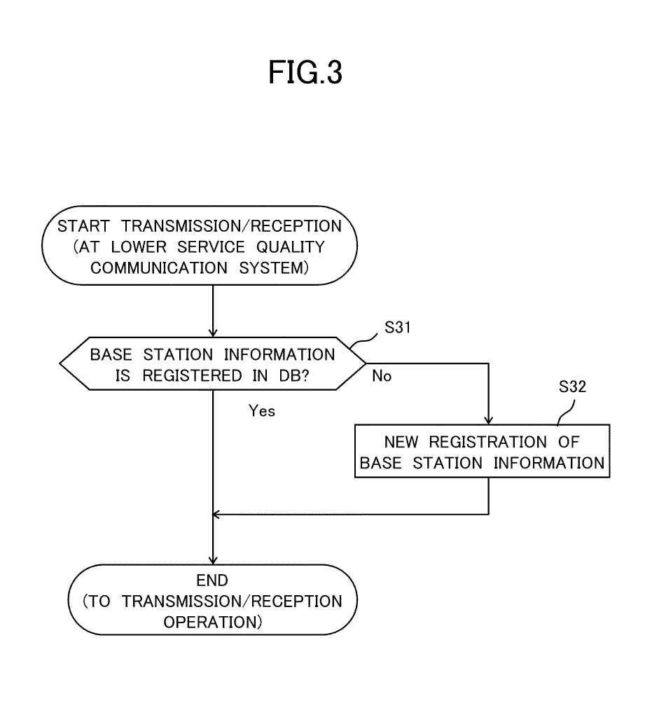

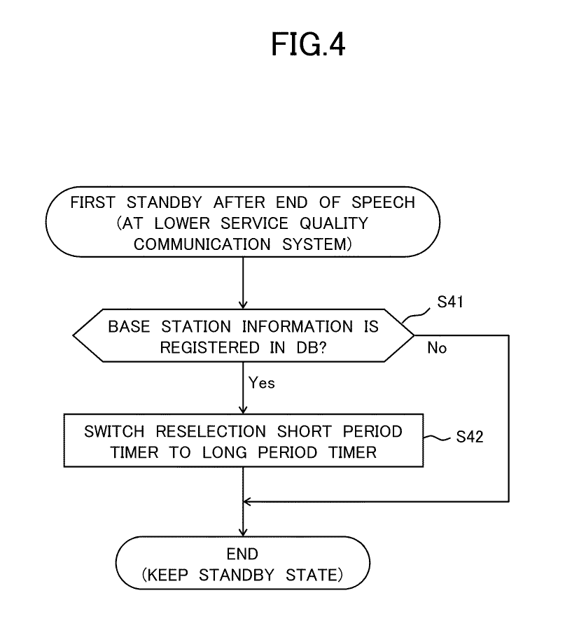

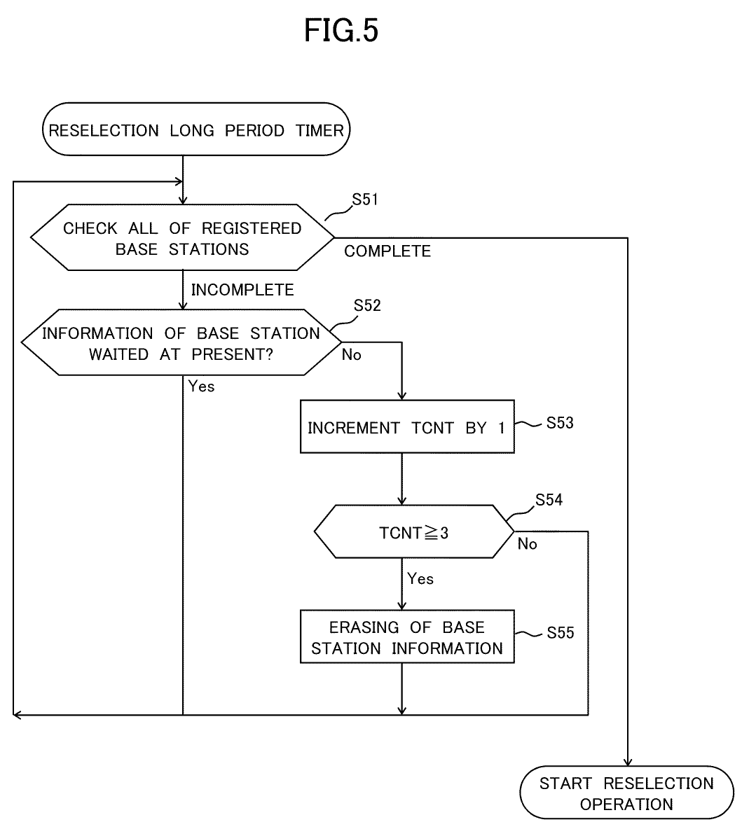

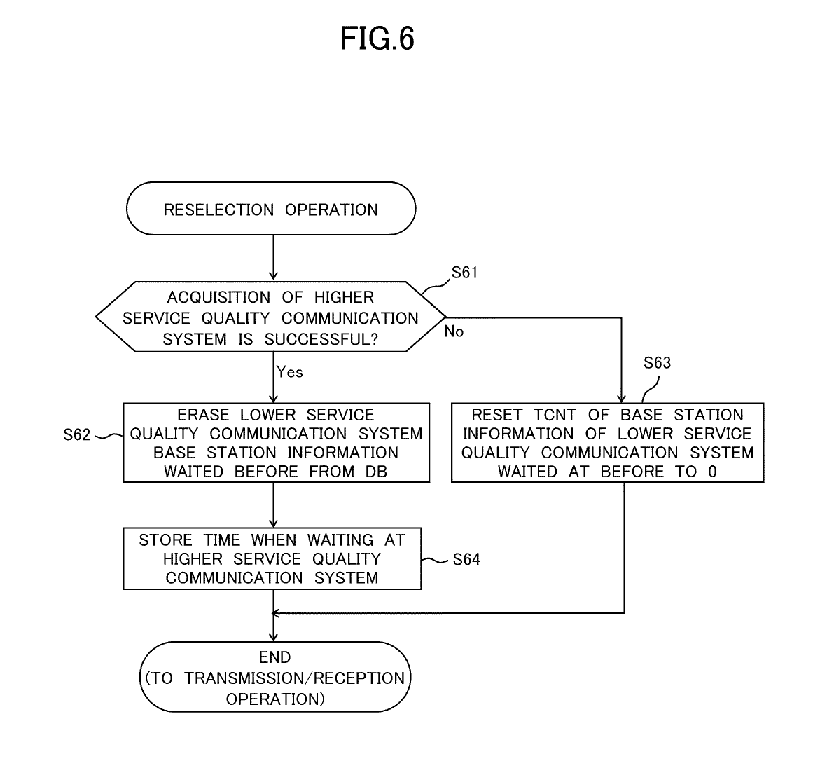

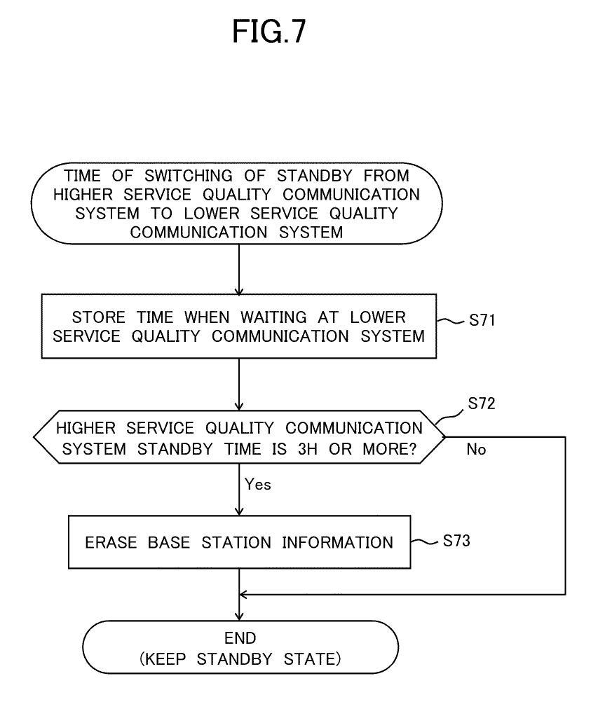

### BRIEF DESCRIPTION OF THE DRAWINGS

[FIG. 1] A block diagram showing the internal configuration of a wireless communication terminal apparatus according to an embodiment of the present invention.

[FIG. 2] A diagram showing an example of a data structure of a memory part used in a wireless communication terminal apparatus according to an embodiment of the present invention.

[FIG. 3] A flow chart showing an operation at the time of start of transmission/reception of a wireless communication terminal apparatus according to an embodiment of the present invention.

[FIG. 4] A flow chart showing a standby (registration) operation after the end of speech of a wireless communication terminal apparatus according to an embodiment of the present invention.

[FIG. 5] A flow chart showing an operation at the time of reaching the end of a count of a reselection timer of a wireless communication terminal apparatus according to an embodiment of the present invention.

[FIG. 6] A flow chart showing a reselection operation of a wireless communication terminal apparatus according to an embodiment of the present invention.

[FIG. 7] A flow chart showing a reselection operation at the time of shift to a lower service quality communication system of a wireless communication terminal apparatus according to an embodiment of the present invention.

### EXPLANATION OF NOTATIONS

11 . . . communication part, 12 . . . operation part, 13 . . . audio processing part, 14 . . . speaker, 15 . . . microphone, 16 . . . display part, 17 . . . memory part, 18 . . . control part, 181 . . . main control part, 182 . . . reselection processing part, 183 . . . timer monitor part, 184 . . . base station information registration processing part, and 185 . . . reselection processing activation control part.

### BEST MODE FOR CARRYING OUT THE INVENTION

In recent years, mobile terminals capable of waiting (idling) at a plurality of frequency bands (hereinafter, referred to as “communication systems”) have begun to appear. Namely, such a mobile terminal apparatus is required to always select the best base station in terms of the signal state or traffic. Reselection processing using the above neighbor base station information to changing the standby (registration) communication systems is known as well.

For example, in the CDMA2000_{—}1x system in Japan, infrastructure of the 800 MHz band (band class 3) was built in the past. Traffic had begun to become congested, therefore the newly assigned 800 MHz band (band class 0) and 2 GHz band (band class 6) infrastructures were newly built. In such an environment (tri-band correspondence), naturally the traffic in the new frequency bands is lighter. For this reason, these should be set at a higher priority for acquisition.

However, in terms of infrastructure, the band class 3 is an overwhelmingly more stable cover area. Therefore, when once waiting (idling) at the band class 3, the mobile terminal apparatus operates without any problem by just idle hand-off changing only a PN (Pseudo Noise) offset in this frequency band. For this reason, unless there is an opportunity for idle hand-off bridging frequencies based on the neighbor base station information described above, a terminal apparatus will never change to standby (registration) at the Band Class 6 or Band Class 0.

To solve the above problem, “reselection processing” is known. The “reselection processing” referred to here is the technique of having a mobile terminal apparatus, in a state waiting (idling) at any frequency band, release that waiting (idling) state at that frequency band once (release the session), acquire another frequency band with a higher priority, and, if the frequency band with a higher priority exists at the periphery of that mobile terminal apparatus, change the frequency band for waiting (idling) to the frequency band of a higher level by registering the new position at that frequency band.

FIG. 1 is a block diagram showing the internal configuration of a wireless communication terminal apparatus according to an embodiment of the present invention. Here, a mobile phone is exemplified as the wireless communication terminal apparatus.

As shown in FIG. 1, the mobile phone is configured by a communication part 11, operation part 12, audio processing part 13, speaker (hereinafter, referred to as SP) 14, microphone (hereinafter, referred to as MIC) 15, display part 16, memory part 17, and control part 18.

The communication part 11 acquires a plurality of communication systems and performs wireless communication with a network side apparatus including a not shown base station connected to a communication network according to a communication protocol of for example CDMA2000 1x (hereinafter, simply referred to as 1x) or EVDO.

Note that, EVDO communication is faster than 1x communication. 1x communication, unlike EVDO communication, has the characteristic feature that it supports audio communication in addition to data communication

The operation part 12 has, for example, a power key, a speak key, number keys, letter keys, direction keys, an execute key, a send key, and other keys to which various functions are assigned. When these keys are operated by the user, it generates signals corresponding to those operation contents and inputs these as an instruction of the user to the control part 18.

The audio processing part 13 performs the processing of the audio signal output from the SP 14 and audio signal input at the MIC 15.

Namely, the audio processing part 13 amplifies audio input from the MIC 15, performs analog-to-digital conversion, further applies encoding or other signal processing to it to convert it to digital audio data, and outputs the result to the control part 18.

Further, the audio processing part 13 applies decoding, digital-to-analog conversion, amplification, or other signal processing to the audio data supplied from the control part 18 to convert the digital audio data to an analog audio signal and outputs the result to the SP 14.

The display part 16 is configured by using, for example, a liquid crystal display panel, an organic EL (electro-luminescence) panel, or other display device and displays an image in accordance with a video signal supplied from the control part 18.

For example, the display part 16 displays a phone number of a destination at the time of a send operation, a phone number of the other party at the time of the reception, contents of received mail and transmitted mail, the date, time, remaining battery power, success of a send operation, a standby (registration) screen, and other various information and images.

The memory part 17 stores various types of data utilized for processing at the control part 18. The memory part 17 holds, for example, application programs executed by the control part 18, an address book for managing personal information such as phone numbers and e-mail addresses of other parties, an audio file for playing back an incoming call sound and an alarm sound, an image file for the standby (registration) screen, various types of setting data, temporary data utilized in the processing process of the programs, and so on.

Here, further, it is considered that the neighbor base station information is stored. Specifically, as shown in FIG. 2, for each lower service quality base station, other than the base station information comprised of the frequency channel, pilot PN, SID (Sector ID), and NID (Network ID), a timer counter (TCNT) performing update management of the base station information is assigned and stored. Details of the timer counter (TCNT) will be explained later.

Note that, the above memory part 17 is configured by, for example, a nonvolatile memory device (flash memory), a random accessible memory device (SRAM or DRAM), or the like.

The control part 18 centrally controls the entire operation of the mobile phone.

Namely, the control part 18 controls the operations of the blocks explained above so that various types of processing of the mobile phone are executed in a suitable sequence in accordance with the operation of the operation part 12. Here processing of the parts are, for example, speech carried out through a line exchange network, preparation and transmission/reception of e-mails, viewing of Internet Web (World Wide Web) sites, and other control. Further, operations of the blocks are, for example, transmission/reception of signals at the communication part 11, input/output of audio at the audio processing part 13, and display of an image in the display part 16.

The control part 18 is provided with a computer (microprocessor) executing processing based on a program (operating system, application program, etc.) stored in the memory part 17 and runs the processing explained above according to the sequence instructed in this program. Namely, the control part 18 sequentially reads command codes from the operating system, application program, or other program stored in the memory part 17 to execute the processing.

The control part 18 further performs acquisition processing for shifting to standby (registration) in a communication system with a high priority when waiting (idling) at a communication system with a low priority. Namely, first, when the communication is carried out when waiting (idling) at a communication system with a low priority, the base station information used is registered in the memory part 17. Then, when waiting (idling) after the end of the communication, it is judged whether or not the base station information of that base station is registered in the memory part 17. As a result, when it is judged that the base station information of that base station is contained in the base station information, a first timer (long period timer) which will be explained later is used. When it is judged that the base station information of that base station is not contained in the base station information, a second timer (short period timer) is used to activate the reselection processing.

The control part 18 is configured by, as shown in FIG. 1 showing its internal configuration broken down into functions, a main control part 181, reselection processing part 182, timer monitor part 183, base station information registration processing part 184, and reselection processing activation control part 185.

Note that the functions of these blocks are achieved by running programs stored in the memory part 18 by the control part 18. These do not indicate only functions stored substantially differentiated from other blocks in the control part 18. The control part is expressed divided into processing parts just for simplification of the explanation.

The main control part 181 performs the acquisition processing for shifting to standby (registration) at a communication system with a high priority when waiting (idling) at a communication system with a low priority.

When communication is carried out when waiting (idling) at a communication system with a low priority, the main control part 181 registers the base station information used in the memory part 17. When the communication ends and again standing by, it judges whether or not the base station information of that base station is registered in the memory part 17.

The main control part 181 realizes the function of the control part 18 of activating the reselection processing by using the later explained first reselection timer (long period reselection timer) when it is judged that the information of the base station is contained in the base station information and using the second reselection timer (short period reselection timer) when it is judged that the information of the base station is not contained. For this reason, the main control part 181 performs sequence control of function blocks 182 to 185 explained later.

The reselection processing part 182 has the function of performing acquisition processing for shifting to standby (registration) at a communication system with a high priority when waiting (idling) at a communication system with a low priority.

The reselection is carried out for each predetermined period at a time interval counted by the later explained reselection timer. First, the communication system at standby (registration) at the stage when the reselection timer reaches the end of its count is released once (substantially shifted out of service area), then the communication systems are scanned in order from the highest priority prescribed by a PRL (Preferred Roaming List). As a result, when existence of a communication system of a higher service quality than that at the stage where the timer reaches the end of is count can be confirmed, the standby (registration) state is shifted to this higher service quality communication system. Further, even if a higher service quality communication system is not found, the original communication system exists, therefore standby (registration) at the original communication system is returned to in the worst case.

The timer monitor part 183 includes a first reselection timer activating a shift to standby (registration) at a high priority communication system by the reselection processing part 182 (referred to as a “long period timer 201” here) and a second reselection timer having a period shorter than that of the first reselection timer (referred to as a “short period timer 202” here).

These reselection timers 201 and 202 are set in initial values by the main control part 181, start counting, and notify the ends of their counts to the main control part 181.

Note that, the long period timer 201 is a timer used for activating the reselection processing assuming a case where the standby (registration) state will continue for a long time, while the short period timer 202 is a reselection timer used for activating the reselection processing at the time of end of speech or a hand-off.

Incidentally, the reselection timer processing is processing for confirming whether or not there is a higher service quality communication system. Therefore, at a stage of achieving successful standby (registration) at the best service quality (highest priority) communication system on the PRL, the reselection timer processing is suspended.

The base station information registration processing part 184 has a function of registering the base station information used in the memory part 17 when communication is carried out at the time when the communication part 11 is waiting (idling) at a low priority communication system.

Further, the base station information registration processing part 184 updates any timer counter (TCNT) corresponding to base station information of a base station other than that used for the communication immediately before among the timer counters (TCNT) individually set for the base station information stored in the memory part 18 when the long period timer 201 reaches the end of its count and deletes the corresponding base station information from the memory part 17 when this timer counter (TCNT) reaches a predetermined number.

Further, when the communication part 11 fails in acquisition at the reselection processing by the reselection processing part 182, the base station information registration processing part 184 resets the value of the timer counter (TCNT) corresponding to the base station information of the base station waited (idled) at immediately before.

Further, when the reselection processing part 182 waits at a high priority communication system, the base station information registration processing part 184 deletes the base station information concerning the base station waited (idled) at immediately before from the base station information stored in the memory part 17.

Further, when the reselection processing part 182 waits at a high priority communication system over a predetermined time, the base station information registration processing part 184 deletes all of the base station information stored in the memory part 17.

Further, where waiting (idling) at a high priority communication system by the reselection processing part 182 is contained in the predetermined time, the base station information registration processing part 184 updates the timer counter (TCNT) corresponding to the base station information stored in the memory part 17 in accordance with the waiting (idling) time.

When the communication by the communication part 11 ends and standing by, the reselection processing activation control part 185 judges whether or not the base station information of that base station is registered in the memory part 17. Further, the base station has a function of setting the timer for activating the reselection processing part 182 by using the long period timer 202 when it is judged that the base station information of that base station is contained in the base station information and using the short period timer 202 when it is judged that the base station information of that base station is not contained.

Note that, all of the function blocks 182 to 185 described above are activated and operated under sequence control by the main control part 181.

FIG. 3 to FIG. 7 are flow charts shown for explaining the operation of a wireless communication terminal apparatus according to an embodiment of the present invention and show the operation at the time of the start of transmission/reception (FIG. 3), waiting (idling) operation after the end of the speech (FIG. 4), the operation at the time of the reselection timer reaches the end of its count (FIG. 5), the reselection operation (FIG. 6), and the reselection operation at the time of shift to a lower service quality communication system (FIG. 7).

A detailed explanation will be given below of the operations of the wireless communication terminal apparatus according to the embodiment of the present invention shown in FIG. 1 and FIG. 2 with reference to the flow charts of FIG. 3 to FIG. 7.

First, the operation at the time of the start of transmission/reception will be explained with reference to the flow chart of FIG. 3.

At the time of generation of a transmission/reception request and start of a transmission/reception operation at a lower service quality communication system with a low priority, the wireless communication terminal apparatus (control part 18) refers to the memory part 17 and judges whether or not the base station information of the base station which has been communicated with up to immediately before (step S31).

Here, if registered, the wireless communication terminal apparatus performs the transmission/reception operation, while if not registered, the wireless communication terminal apparatus newly registers that base station information (step S32). Note that, at the time of new registration, the wireless communication terminal apparatus sets a value “0” in the corresponding timer counter (TCNT).

Next, in the first standby (registration) state after the end of speech at a lower service quality communication system, as shown in the flow chart of FIG. 4, the reselection processing activation control part 185 compares the base station information of the base station waited (idled) at first with the base station information stored in the memory part 17 (step S41). Then, when there is matching base station information (step S41 “Yes”), counting by the short period timer 202 activated at the time of the end of the speech is suspended and the long period timer 201 is switched to (step S42).

On the other hand, when there is no matching base station information (step S41 “No”), the reselection processing activation control part 185 continues the standby (registration) state by the short period timer 202, activates the reselection processing part 182 by detection of the end of count of the short period timer 202 by the timer monitor part 183, and instructs the start of the reselection operation.

Next, the operation at the time of the reselection timer reaches the end of its count when controlling a count period of the timer counter (TCNT) to a whole multiple of the long period timer 201 will be explained by using the flow chart of FIG. 5.

In FIG. 5, under the control by the main control part 181, the base station information registration processing part 184 refers to all of the base station information stored in the memory part 17 whenever the long period timer 201 reaches the end of its count (TO) (step S51 “Incomplete”) and increments the timer counters (CNT) corresponding to the base station information of the base stations other than that waited (idled) at at present by “1” (step S52 “No”, S53).

Further, when the timer counters (CNT) exceed a predetermined value (step S54 “Yes”), for example, when they exceeds a value “3”, the corresponding base station information is erased (step S55).

In this regard, if the long period timer 201 is set to 1 hour and the short period timer 202 is set to tens of seconds, the timer counter showing “3” means that 3 hours have passed. That is, the base station information registration processing part 184 deletes the information of a base station if waiting (idling) at a lower service quality system continuously for at least 3 hours from the registration of the base station.

Next, as shown in the flow chart of FIG. 6, when the end of the count of the long period timer 201 is detected by the timer monitor part 183, and a higher service quality communication system with a high priority can be acquired by the reselection processing part 182 after that (step S61 “Yes”), the base station information registration processing part 184 refers to the memory part 17, then, if the information of base station waited (idled) at immediately before is registered in the memory part 17, erases that information (step S62).

Then, the time when waiting (idling) at the higher service quality communication system is stored in the memory part 17, and the routine proceeds to the transmission/reception operation (step S64).

On the other hand, when a higher service quality communication system cannot be acquired at the reselection processing part 182 (step S61 “No”) and information of the base station waited (idled) at immediately before is registered in the memory part 17, the timer counter (TCNT) corresponding to that base station information is reset to the value “0” of the lowest possibility of being erased and the reselection operation is ended (step S63).

Due to this, an area where the reselection failed irrespective of the reselection being once carried out, that is, an area with a low success in acquisition of a higher service quality system, remains in the memory part 17 for a longer time, therefore the reselection in an area where there is no higher service quality system can be suppressed as much as possible. This leads to saving of power.

Note that, as shown in the flow chart of FIG. 7, the base station information registration processing part 184 stores the time at the time of standby (registration) at a lower service quality communication system such as the time of switching of the standby (registration) state from a higher service quality communication system to a lower service quality communication system (step S64 of FIG. 6, step S71 of FIG. 7) and compares a time difference between this time and a time in a case of the next standby (registration) at a lower service quality communication system with a predetermined value (“3 hours” here). When this time difference exceeds the predetermined value (step S72 “Yes”), all base station information registered in the memory part 17 is erased (step S73). Further, when this time difference does not exceed the predetermined value, that is, the time difference is less than “3 hours” (step S72 “No”), for example, it is also possible to add “1” to a timer counter (TCNT) where the passed time is 1 hour, add “2” to a timer counter where the passed time is 2 hours, and erase only the base station information exceeding the value “3”.

As explained above, the wireless communication terminal apparatus (control part 18) according to the embodiment of the present invention has a first reselection timer activating the reselection processing for shifting to standby (registration) at a high priority communication system when the communication part 11 is waiting (idling) at a low priority communication system (long period timer 201) and a second reselection timer having a shorter period than the first reselection timer (short period timer 202). Then, when communication is carried out at the time of standby (registration) at a communication system with a low priority, the base station information used is registered in the memory part 17. After the end of the communication when standing by, it is judged whether or not the base station information of that base station is registered in the memory part 17. Then, when it is judged that the base station information of that base station is contained in the base station information stored in the memory part 17, the reselection processing is executed by using the long period timer 201, while when it is judged that the base station information of that base station is not contained, the processing is executed by using the short period timer 202. Due to this, the opportunities for useless reselection operations and acquisition operations are reduced, therefore the current consumption can be suppressed and the waiting (idling) time reduced, so the usability can be improved.

Further, in order to manage the base station information stored in the memory part 17, timer counters (TCNT) are provided. When the long period timer 201 reaches the end of its count, the timer counters (TCNT) corresponding to the base station information of base stations other than that used for the communication immediately before among the timer counters (TCNT) individually set for the base station information stored in the memory part 17 are updated. After that, by deleting the corresponding base station information from the memory part 17 when a timer counter (TCNT) reaches a predetermined number or by resetting the value of the timer counter (TCNT) corresponding to the base station information of the base station waited (idled) at immediately before when the acquisition of the communication system fails at the reselection processing, the reselection operation can be more optimized. Further, the standby (registration) state in a more stable communication system can be maintained for a long time, therefore missed reception of incoming calls or the like can be suppressed as much as possible.

Note that, according to the wireless communication terminal apparatus according to the embodiment of the present invention described above, only a mobile phone was exemplified as the wireless communication terminal apparatus, but application to for example a PDA (Personal Digital Assistant) or game machine having the same configuration is possible in the same way.

Further, the functions of the component blocks of the wireless communication terminal apparatus (control part 18) according to the embodiment of the present invention shown in FIG. 1 may be all realized by software or at least a portion thereof may be realized by hardware.

For example, the data processing in the main control part 181, reselection processing part 182, timer monitor part 183, base station information registration processing part 184, and reselection processing activation control part 185 may be realized by one or more programs on the computer or at least a portion thereof may be realized by hardware.

1. A wireless communication terminal apparatus able to adapt a plurality of communication systems synchronized temporally each other, said wireless communication terminal apparatus comprising:
a communication part communicating with base stations by selectively acquiring any one of the plurality of said communication systems;
a memory part storing a plurality of sets of base station information; and
a control part capable of executing reselection processing that executes acquisition processing when said communication part is registrated at a low priority first communication system, for shifting said communication part to registrate at a high priority second communication system, wherein,
when communication starts in a state of registration at the low priority first communication system, said control part registers the base station information of the base station used for the communication in the memory part,
when the communication ends and the operation shifts to idle, said control part judges if the base station information of a registrated base station is contained in the base station information stored in the memory part,
said control part sets a first reselection timer when it is judged that the base station information of the registrated base station is contained,
said control part sets a second reselection timer shorter in period than the first reselection timer when it is judged that the base station information of the registrated base station is not contained, and
said control part executes the reselection processing when either the set timer of the first reselection timer or second reselection timer reaches the end of its count.

2. A wireless communication terminal apparatus as set forth in claim 1, wherein
the base station information stored in the memory part are linked with counters, and
when the first reselection timer reaches the end of its count, said control part makes the counters other than that for the base station used for communication immediately before setting the first reselection timer among the counters of the base station information stored in the memory part approach a predetermined value by a constant quantity, and
said control part deletes the base station information linked with a counter reaching the predetermined number from the memory part when any counter reaches the predetermined number.

3. A wireless communication terminal apparatus as set forth in claim 2, wherein
when performing the reselection processing and failing in the acquisition processing of the high priority second communication system, said control part resets a count value corresponding to the base station information of the base station registrated at immediately before.

4. A wireless communication terminal apparatus as set forth in claim 2, wherein the control part performs the reselection processing and deletes the base station information of the base station idled at immediately before from the memory part when able to idle at the second communication system with a high priority.

5. A wireless communication terminal apparatus as set forth in claim 2, wherein
said control part deletes all of the base station information of the memory part when a registrated time at the high priority second communication system continues for a predetermined time or longer.

6. A wireless communication terminal apparatus as set forth in claim 2, wherein
when a registrated time at the high priority second communication system is within a predetermined time, said control part makes the counter for each of the base station information of the memory part approach the predetermined value by the amount of value corresponding to the registrated time.

7. A wireless communication terminal apparatus able to adapt a plurality of communication systems synchronized temporally each other, said wireless communication terminal apparatus comprising:
a reselection means for executing acquisition processing when the terminal apparatus is registrated at a low priority first communication system, for shifting the registrated communication system to a high priority second communication system;
a timer means for activating the reselection means;
a storing means for storing a plurality of base station information;
a registering means for registering the base station information used in the storing means when the communication is carried out in a state of registration at a communication system with a low priority; and
a judging means for judging if the base station information of the registrated base station is contained in the base station information stored by the storing means when ending the communication and shifting to registration, wherein
the timer means includes a long period timer and a short period timer,
the terminal apparatus performs control a next execution of the reselection means by using the short period timer when the judging means judges that the base station information of the registrated base station is not contained in the base station information, and
the terminal apparatus performs control a next execution of the reselection means by using the long period timer when judging that the base station information of the registrated base station is contained.

8. A wireless communication terminal apparatus as set forth in claim 1, wherein each of the plurality of communication systems is a communication system to which a different band class in the CDMA2000_{—}1x scheme is assigned

9. A wireless communication terminal apparatus as set forth in claim 8, wherein the low priority first communication system is a communication system to which a band class 3 is assigned, and the high priority second communication system is a communication system to which a band class 0 is assigned.

10. A wireless communication terminal apparatus as set forth in claim 1, wherein the high priority second communication system is a communication system which becomes able to be used newer than the low priority first communication system.

11. A communication system acquisition control method in a wireless communication terminal apparatus able to adapt a plurality of communication systems synchronized temporally each other and having a communication part communicating with base stations by selectively acquiring any one of the plurality of communication systems, including:
a registration step of registrating base station information of a base station to be used for communication when communication starts in a state of registration at a low priority first communication system;
a judgment step of judging if the base station information of a registrated base station is contained in the base station information registered in the registration step when shifting to registration after the communication ends;
a setting step of setting a first reselection timer when it is judged in the judgment step that the base station information of the registrated base station is contained and setting a second reselection timer shorter in period than the reselection timer when it is judged that the base station information of the registrated base station is not contained, and
a reselection step of executing reselection processing for acquisition processing when the terminal apparatus is registrated at the low priority first communication system, for shifting the registration of the terminal apparatus to a higher priority second communication system with than the low priority first communication system when either a set timer of the first reselection timer or second reselection timer reaches the end of its count.
